(19) United States
(12) Patent Application Publication
(10) Pub. No.: US 2011/0267920 A1
(43) Pub. Date: Nov. 3, 2011

(54) Method and Apparatus for Controlling Residence Time Distribution in Continuous Stirred-Tank Reactors

(75) Inventors: Carlos Corleto, Seabrook, TX (US); Shane Steagall, Houston, TX (US)

(73) Assignee: Fina Technology, Inc., Houston, TX (US)

(21) Appl. No.: 12/768,760

(22) Filed: Apr. 28, 2010

(51) Int. Cl. B01F 7/16

(52) U.S. Cl. 366/315

(57) ABSTRACT

The present invention includes an apparatus and method for narrowing the residence time distribution of a continuous stirred-tank reactor, or CSTR, which includes the optional procedures of: decreasing the vertical cross-sectional area of the reactor's agitator blades; decreasing the RPM of the agitator blades; and increasing the reactor's L/D ratio. The CSTR can be used in the production of monovinylidene aromatic polymers, such as high impact polystyrene.

### CROSS-REFERENCE TO RELATED APPLICATIONS

Not applicable.

### FIELD

The present invention generally relates to continuous stirred-tank reactors that can demonstrate increased plug flow behavior, such as those used in the production of monovinylidene aromatic polymers.

### BACKGROUND

The plug flow reactor model is well known in the art of reactor design, and reactors that demonstrate or approximate plug flow are used in a variety of processes. Ideal plug flow behavior is a mixing condition in which no mixing occurs in the axial direction and all material within the reactor experience identical residence time. Another reactor model, the continuous stirred tank reactor, demonstrates complete or near complete mixing in all directions, such that the reaction mixture is substantially uniform in all areas of the reactor at all times, and there is an exponential decrease in residence times experienced by material within the reactor. Continuous stirred tank reactors typically yield broad residence time distributions due to the mixing conditions of the continuous stirred tank reactor.

Plug flow behavior is useful when it is desired to have little or no back-mixing in the reaction chamber and uniform residence time for all material within the reactor. Residence time refers to the amount of time that elapses from the moment material enters the reactor until the moment that same material exits the reactor. One process in which a plug flow reactor has been used is in the production of monovinylidene aromatic polymers, such as styrene, and especially in the production of high impact polystyrene, or HIPS. High impact polystyrene is a rubber-modified plastic that shows enhanced toughness and impact absorption over regular polystyrene and is used in the production of a variety of products, including toys, casings for appliances, and containers for food and medical supplies.

Plug flow can be useful in the production of HIPS by ensuring that polymer exiting the reactor has reacted to the same extent. The term “plug flow” comes from the idea of a series of plugs moving from the entrance to the exit of a reactor. The plugs of material do not mix with one another and thus each is exposed to the reactor conditions for an equal amount of time, and each exits the reactor having been reacted to the same degree. This concept is useful in polymer production as it allows for greater control of molecular weight, branching, rubber particle size, and other characteristics of HIPS.

Plug flow has been approximated in a variety of reactor types, such as extruders, tubular reactors, and linear flow reactors. Stirred tubular reactors are commonly used in the production of HIPS. Such reactors generally consist of a long, tube-shaped reaction chamber that houses a motor-powered shaft bearing a series of agitator blades for mixing.

Continuous stirred-tank reactors have been used in the production of HIPS. A continuous stirred-tank reactor, or CSTR, reactor type is, under ideal circumstances, based on the assumption that the flow at the inlet is completely and instantly mixed into the bulk of the reactor. In an ideal CSTR, the reactor and the outlet fluid have identical, homogeneous compositions at all times. The ideal CSTR thus has a broad residence time distribution with an exponential type tail.

Plug flow behavior can be measured by calculating the ratio of standard deviation of residence time (σ) over mean residence time (tₘ), or σ/tₘ. For a plug flow reactor, it is desirable that all material passing through the reactor have identical residence times, and thus a should be equal to zero. Thus, σ/tₘ should also equal zero. A narrowing of the residence time distribution reflects an improvement in plug flow behavior.

Therefore, for processes that benefit from plug flow, it is desirable to modify a reactor to imitate ideal plug flow as much as possible. It is towards this end that the present invention is directed.

### SUMMARY

Embodiments of the present invention present an apparatus and method for enhancing the plug flow behavior of a continuous stirred-tank reactor, or CSTR, whereby the plug flow behavior is enhanced by a reduction in σ/tₘ.

In one embodiment, the method includes narrowing the residence time of the reactor by decreasing the vertical cross-sectional area of the reactor's agitator blades.

In another embodiment, the method includes narrowing the residence time distribution by decreasing the RPM of the agitator blades.

In another embodiment, the method includes narrowing the residence time distribution by adjusting the L/D ratio of the reactor.

Other possible embodiments include two or more of the above aspects of the invention. In one embodiment, the method includes all of the above aspects and the various procedures can be carried out in any order.

The reactor can be used in any process in which enhanced plug flow behavior is desirable. The reactor can be used in the production of polymers, such as monovinylidene aromatic polymers. The reactor can be used in the production of high impact polystyrene, and can operate as a plug flow inversion reactor in the production of HIPS.

### BRIEF DESCRIPTION OF DRAWINGS

FIG. 1 shows a desirable HIPS product.

FIG. 2 shows an embodiment of a continuous stirred-tank reactor (CSTR).

FIG. 3 shows a CSTR having vertically oriented agitators and longitudinal baffles.

FIG. 4 shows a CSTR, without baffles, having horizontally oriented agitators.

FIG. 5 shows a comparison of particle flowpaths for a reactor at different RPMs.

FIG. 6 is a graph of a comparison of RTD for an ideal CSTR to a Foshan reactor model.

FIG. 7 shows the CFD model that depicts three radial zones for the reactor model having three vertical blades and longitudinal baffles at 38 rpm.

FIG. 8 is a graph of a comparison of RTD for an ideal CSTR to a four bladed Foshan reactor model with a 92% level.

FIG. 9 shows the CFD model that depicts four radial zones for the reactor model having four vertical blades at 38 rpm.

FIG. 10 is a graph of a comparison of RTD for an ideal CSTR to a Foshan reactor model having four horizontal blades and at a 68% level.

### DETAILED DESCRIPTION

The present invention includes an apparatus and method for improving the plug flow behavior of a stirred-tank reactor, such as a continuous stirred-tank reactor, or CSTR. The method contains several aspects and embodiments, which present a number of optional procedures that are disclosed herein. The optional procedures can be carried out in a variety of combinations, ordering, and/or groupings. The method is not limited to any one specific procedure or grouping of procedures.

The plug flow behavior of a reactor indicates how well the reactor will behave according to the plug flow reactor model, wherein back-mixing is limited and residence time is uniform. Plug flow behavior can be measured by calculating the ratio of standard deviation of residence time (a) over mean residence time (tₘ), or σ/tₘ. For a plug flow reactor, it is desirable that all material passing through the reactor have identical residence times, and thus a should be equal to zero. Thus, σ/tₘ should also equal zero. Reactors, such as CSTRs, can therefore be said to better approximate plug flow the nearer their ratio of σ/tₘ is to zero. Statements referring to an improvement in plug flow behavior by some percent, therefore, refer to by what percent closer the reactor's σ/tₘ value is to zero.

A reduction in a reactor's standard deviation of residence time (a) is reflected in a narrowing of the resulting plot of RTD versus time. Therefore a reduction in the σ/tₘ value will also result in a narrowing of a plot of the RTD versus time. One method of quantifying the relative narrowing or broadening of a residence time distribution is a comparison of the RTD vs time curves. The time differences between the locations of 10% and 90% of the area under the curve can be compared. A reduction in this time span can be referred to as a narrowing of the RTD while an increase in this time span can be referred to as a broadening of the RTD.

In a conventional continuous stirred-tank reactor, the reactor is defined by a length L and a diameter D. The reactor houses one or more agitator blades attached to a rotatable shaft that is driven by a motor. An inlet for feedstock and an outlet for product are also provided for. The reactor is typically used in a vertical orientation. The reactor can include additional elements, such as internal coils. Any continuous stirred-tank reactor for which enhanced plug flow behavior is desired can be adjusted according to the method of the present invention.

The CSTR can be used for a variety of processes, especially those for which plug flow conditions are desired. Such processes include the production of monovinylidene aromatic polymers. These polymers can be homopolymers or rubber modified polymers of monovinylaromatic monomers, such as styrene, alpha-methyl styrene and ring-substituted styrenes. In particular, the reactor can be used for making polymers such as polystyrene and rubber modified polystyrene. More particularly, the reactor can be used to prepare rubber reinforced polymers of styrene having included therein discrete particles of a crosslinked rubber, such as polybutadiene, the discrete particles of rubber being dispersed throughout the styrene polymer matrix. High impact polystyrene (HIPS) is one prominent example of a rubber modified polymer that this reactor can be used to produce.

The production of HIPS often involves more than one reactor and/or more than one reactor type. Generally, a series of plug flow and continuously stirred-tank reactors are used, wherein the degree of polymerization increases from one vessel to the next. The reactor scheme generally consists of one or more pre-inversion reactors followed by an inversion reactor and then one or more post-inversion reactors. Continuous stirred-tank reactors that exhibit plug flow behavior can be used in the production process. If used as an inversion reactor, a CSTR exhibiting plug flow characteristics can be termed a “plug flow inversion reactor” or PFIR.

Phase inversion refers to a morphological transformation that occurs during the preparation of HIPS. Generally, the feedstock for HIPS preparation includes polybutadiene rubber and styrene monomer, which components are generally immiscible. At the pre-inversion stage of production, a mixture of styrene and polybutadiene forms the continuous phase with a mixture of polystyrene and styrene dispersed therein. As the reaction of styrene into polystyrene progresses and the amount of polystyrene increases, phase inversion occurs, after which the polystyrene/styrene mixture forms the continuous phase with rubber particles dispersed therein. This phase inversion leads to the formation of complex rubbery particles in which the rubber exists in the form of membranes surrounding occluded domains of polystyrene. The size and distribution of the rubber particles can influence the physical and mechanical properties of HIPS.

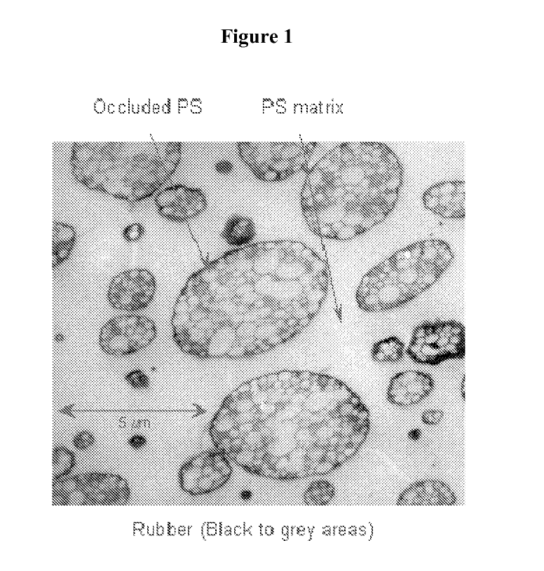

Reducing the amount of rubber used in a HIPS product while maintaining product performance can provide production cost savings, especially for products that require high rubber content to meet market performance. HIPS includes rubber particles with occluded polystyrene (OPS) embedded in a PS matrix. The goal of rubber efficiency is to increase the quantity and size of the occluded polystyrene. Additionally, in order to meet product performance it is important to have narrow mono-modal rubber particle size (RPS) distributions. Thus, in the process of increasing the rubber efficiency it is also important to minimize rubber particle break-up and prevent the formation of a polystyrene product with small RPS. FIG. 1 depicts a HIPS product having desirable RPS characteristics.

There are many factors influencing the particle formation of HIPS. Process operating conditions such as temperature, pressure and production rates have an effect on HIPS. HIPS is also influenced by process design including reactor configuration such as presence of spillback lines, horizontal and vertical orientation of the reactor(s), the reactor internal geometry, condensation lines, and feed location. In addition, HIPS is influenced by diluents, utilizing thermal conversion, and the use of catalysts. Though some of these factors are not directly correlated to one another, each of them contributes to the mechanical properties of the final product.

Plug flow behavior can be useful in an inversion reactor to optimize the formation of rubber particles. Thus, the method according to the present invention can be applied toward a PFIR to enhance its plug flow behavior.

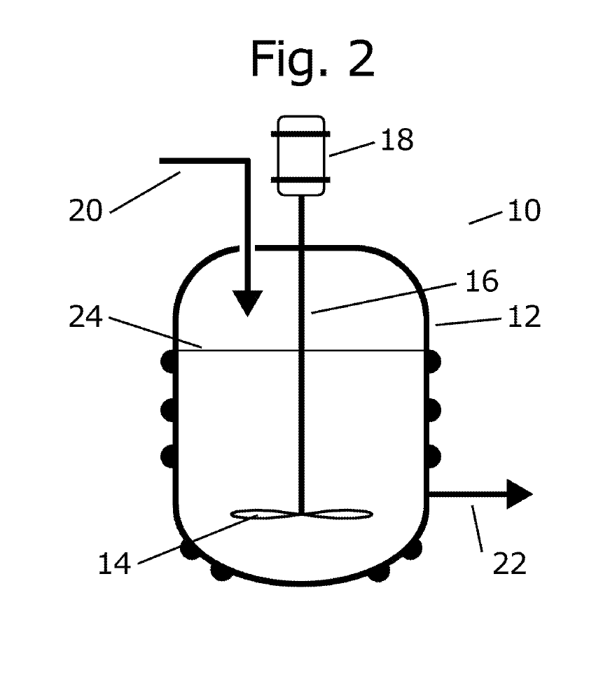

FIG. 2 depicts an embodiment of a stirred-tank reactor. The stirred-tank reactor 10 includes a tank, or vessel, 12 and agitator blades 14 that are attached to shaft 16, which is driven by a motor 18. An inlet flow of fluid 20 enters the tank 12. The rotation of the agitator blades 14 stir the fluid within the tank 12. An outlet flow of fluid 22 leaves the tank 12. The liquid level 24 in the tank 12 can be controlled by adjusting the inlet and outlet flows. In an embodiment, a CSTR contains up to 10 sets of agitator blades. In another embodiment, the CSTR contains from 1 to 6 sets of agitator blades. In a further embodiment, the CSTR contains from 2 to 4 sets of agitator blades. In an embodiment, each set of agitator blades may contain up to 8 agitator blades. In another embodiment, each set of agitator blades may contain from 2 to 6 agitator blades. In a further embodiment, each set of agitator blades may contain from 2 to 3 agitator blades.

In another embodiment, the agitator blades have a vertical cross-sectional area that is chosen to enhance plug flow behavior. The less the vertical cross-sectional area of the agitator blades, the shorter the residence time distribution, or RTD, of the contents of the reactor. This lessening of RTD results in enhanced plug flow behavior.

The agitator blades may be flat-paddle agitator blades. In an embodiment, the flat-paddle agitator blades have a length, width and thickness. In an embodiment, the agitator blades are vertically oriented in the CSTR, wherein the vertical cross-sectional area would be the width multiplied by the length. In another embodiment, the agitator blades are horizontally oriented in the CSTR, wherein the vertical cross-sectional area would be the thickness multiplied by the length. The agitator blades may have a selected vertical cross-sectional area sufficient to narrow the residence time distribution of the stirred-tank reactor. The agitator blades may also be aligned in a manner other than vertical or horizontal, such as for instance at an orientation half way between vertical and horizontal at a 45 degree angle. In an aspect, the agitator blades have a vertical dimension that is from 0.1 inches to 1 foot, optionally from 0.25 inches to 6 inches, optionally from 0.25 inches to 3 inches.

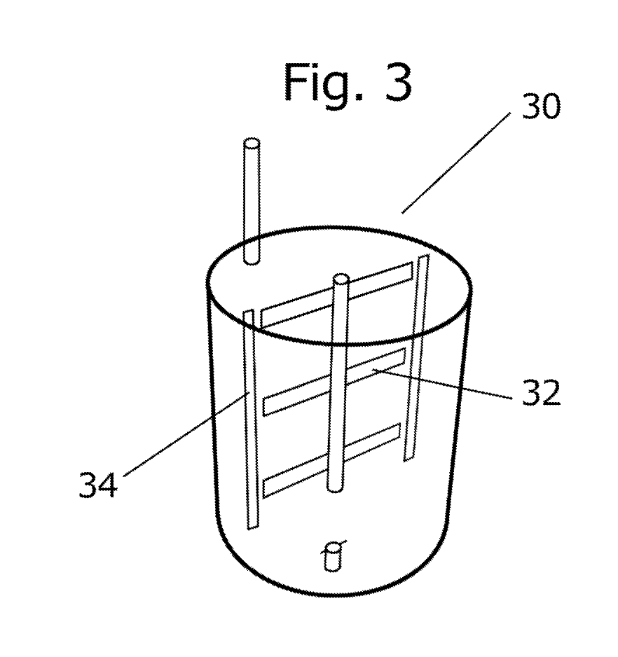

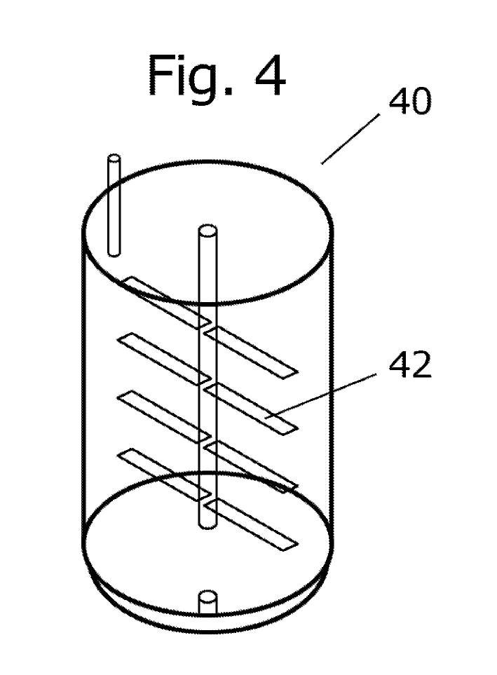

In an aspect, the CSTR does not contain baffles, longitudinal or otherwise, which results in a significant narrowing of the residence time distribution of the reactor. FIG. 3 depicts a CSTR 30 having vertically oriented agitator blades 32 and containing longitudinal baffles 34. FIG. 4 depicts a CSTR 40 containing no baffles and having horizontally oriented agitator blades 42. In an embodiment, the agitator blades can be oriented in a position between horizontal and vertical. In an alternative embodiment, the agitator blades are pitched at angles of from 0° to 180°. In another embodiment, the agitator blades are pitched at angles of from 20° to 160°. In a further embodiment, the agitator blades are pitched at angles of from 40° to 140°. The rotation of the rotating shaft connected to the agitator blades can be in either a clockwise or counter-clock wise rotation.

In another embodiment, an optional spillback stream is removed from a continuous stirred-tank reactor to enhance plug flow behavior. The presence of a spillback stream can lead to greater recirculations within the reactor, especially when the reactor is operated at higher RPMs. Such recirculations can disturb the plug flow pattern. Thus, a stirred-tank reactor can show enhanced plug flow behavior in the absence of a spillback stream. Increasing RPMs can lead to greater recirculations within the reactor from the spillback inlet to the spillback outlet and from the main inlet to the main outlet. In order to minimize such recirculations, the spillback stream can be removed to enhance plug flow behavior. The removal of the spillback stream can include the elimination of any one or more spillback inlets and/or outlets.

A CSTR of the present invention can include any agitator speeds that can enhance plug flow behavior. In an embodiment, the agitators of the CSTR have RPMs of from 0 RPM to 50 RPM. In another embodiment, the agitators of the CSTR have RPMs of from 2 RPM to 20 RPM. In a further embodiment, the agitators of the CSTR have RPMs of from 4 RPM to 12 RPM.

In another embodiment, the RPMs of a continuous stirred-tank reactor are decreased to enhance plug flow behavior. A reduction in the RPMs of the mixing component of the reactor, which generally consists of agitator blades along a central shaft, can reduce back-mixing and thus enhance the plug flow behavior of the reactor.

A CSTR of the present invention can be of any dimensions. In an embodiment, the CSTR is tubular in shape and has a diameter of from 2 feet to 15 feet. In another embodiment, the CSTR has a diameter of from 3 feet to 12 feet. In a further embodiment, the CSTR has a diameter of from 4 feet to 10 feet. In an embodiment, the CSTR has a length of from 5 feet to 25 feet. In another embodiment, the CSTR has a length of from 7 feet to 20 feet. In a further embodiment, the CSTR has a length of from 8 feet to 15 feet.

In another embodiment, the geometric dimensions of a stirred tubular reactor are altered to enhance plug flow behavior. The geometric dimensions of a continuous stirred-tank reactor can be defined in terms of its length to diameter ratio, or L/D ratio. An increase in the L/D ratio can enhance plug flow behavior. The L/D ratio can be increased by either lengthening the reactor or by decreasing its diameter, or both. When altering geometric dimensions, the distribution and shape of the agitator blades can be adjusted accordingly.

A CSTR of the present invention may include any liquid operating level that may improve plug flow behavior. In general it is found that operating at increased levels will improve plug flow behavior. In an embodiment, the CSTR includes a liquid operating level of from 30% to 100%. In another embodiment, the CSTR includes a liquid operating level of from 60% to 100%. In a further embodiment, the CSTR includes a liquid operating level of from 85% to 100%. Operating consideration may not enable an operating level of 100%, in which case a level of from 85% to 99% may be the maximum operating level available.

Each of the aspects listed herein can be taken alone or in combination with other aspects and are not limiting on the invention. Alternate embodiments include those in which two or more of the procedures described herein are combined. In one embodiment, the method of the present invention can include all procedures or aspects described herein.

### EXAMPLES

### Example 1

A base-line model CSTR was designed including vertically oriented radial agitators and longitudinal baffles, as depicted in FIG. 3. To accurately measure the residence time distribution (RTD), the model did not include a spillback line or a recycle line. The model was based on an operating level of 68%.

The production rate, agitator RPM and operating level were manipulated and the RTD was monitored in order to understand the effect of operating conditions on HIPS manufacture. The amount and orientation (vertical or horizontal) of agitator blades in the CSTR model were modified in order to determine the effect of reactor geometry on the RTD. The modifications included changing the operating level from 68% to 92%, adding an additional agitator achieving four total agitator sets, as well as changing the orientation of the agitator blades and operating level of the four bladed model.

To develop a base-line for the reactor the operating conditions and geometry, such as agitation speed (RPM), production rate, the number of agitators and orientation, as well as the reactor level (L/D), were modified to evaluate the change on the RTD. The agitator speed was varied from 38 RPM, which is the normal operating condition of the reactor, down to 0 RPM (as shown in Table 1). Additionally, the production rate was doubled with the agitator speed at the normal operating condition of 38 RPM. The σ/tₘ values were calculated and are tabulated in Table 1.

TABLE 1
CSTR baseline analysis.

| Parameter | σ/tₘ |
|---|---|
| 38 RPM | 0.95 |
| 19 RPM | 0.91 |
| 9.5 RPM | 0.91 |
| 0 RPM | 0.72 |
| Double Production | 0.95 |

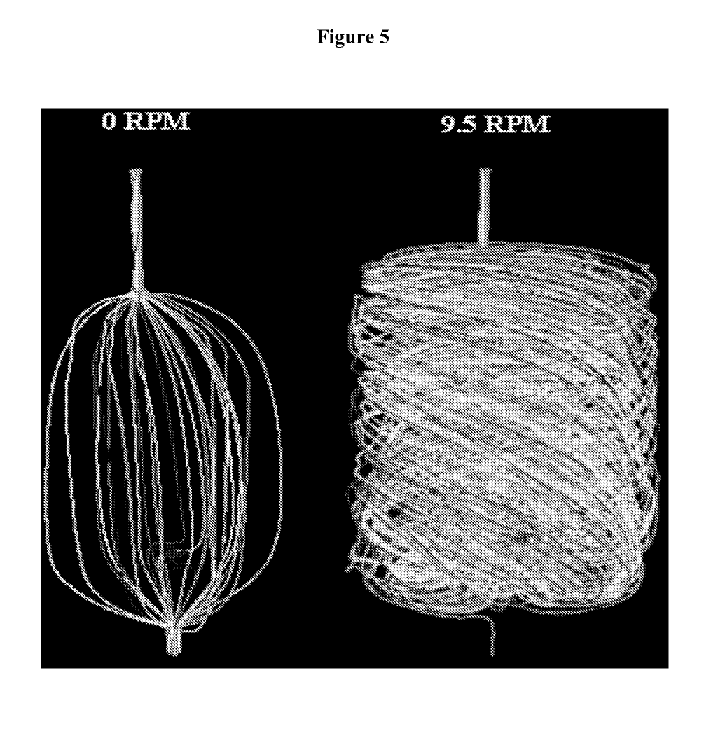

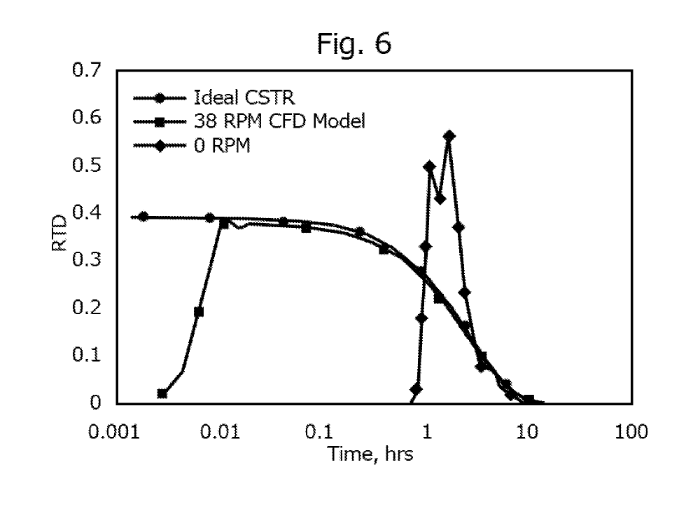

The completed models suggest that for the existing reactor geometry (3 blades, longitudinal baffles, etc.) a much lower agitator speed is required to approach plug flow behavior. Decreasing the rotation speed from 38 RPM to 9.5 RPM results in a reduction of σ/tₘ value of 4.2%. Decreasing the rotation speed from 38 RPM to 0 RPM results in a reduction of σ/tₘ value of 24.2%. Specifically, the model shows that only a 0.72 σ/tₘ can be reached with no agitation. FIG. 5 shows a comparison of particle flowpaths for the reactor at different RPMs. The RTD, which is based upon the flow path all particles follow, is noticeably different as shown in FIG. 6. As illustrated in FIG. 6 the RTD is much narrower for the case of 0 RPM.

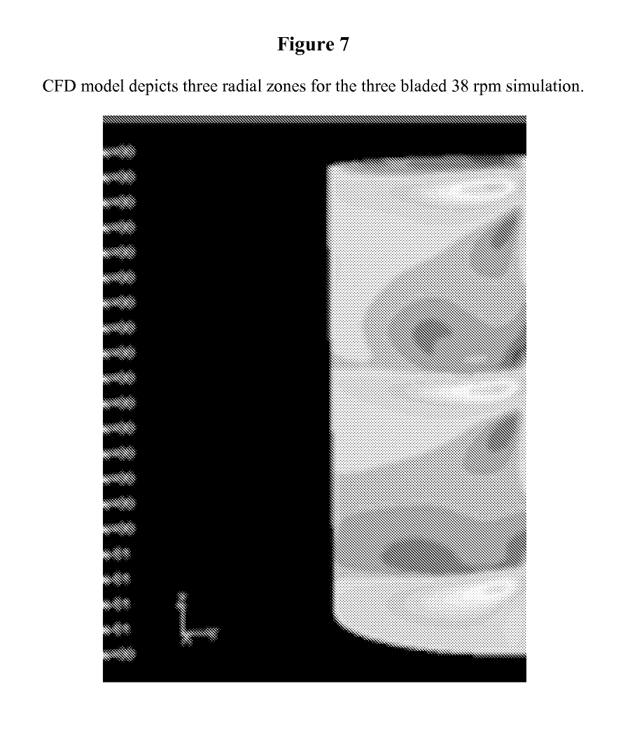

The existing model, at normal operating conditions, has a RTD close to the theoretical CSTR (a theoretical CSTR has a σ/tₘ value of 1) as shown in FIG. 6. A surprising result was how it is noticeable that three radial zones exist, and that at higher agitation speeds significant interaction allows for particle turbulence, which promotes the CSTR behavior. FIG. 7 shows the CFD model that depicts three radial zones for the three bladed simulation at 38 rpm.

### Example 2

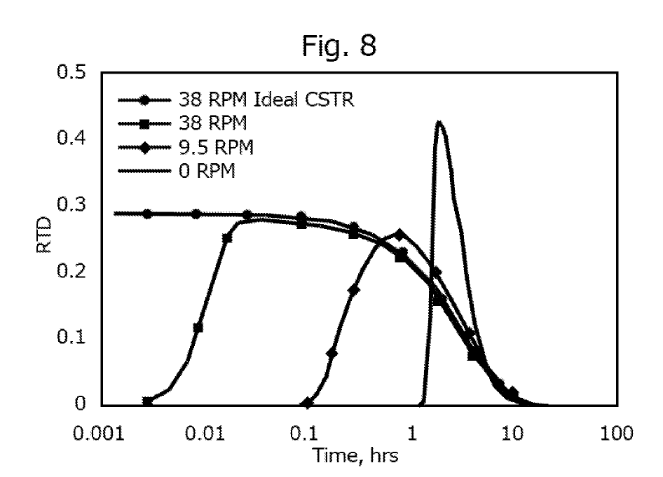

A second model was developed to evaluate an alternate reactor having four vertically oriented blades and an operating level of 92%. In this case decreasing the rotation speed from 38 RPM to 9.5 RPM results in a reduction of σ/tₘ value of 9.5%. Decreasing the rotation speed from 38 RPM to 0 RPM results in a reduction of σ/tₘ value of 30.5%. The higher level shows to have improved the plug flow behavior by effectively creating a larger L/D. The results are shown in Table 2 and FIG. 8. From a comparison of Table 1 data to Table 2 data it can be seen that at 9.5 RPM the σ/tₘ decreased from 0.91 to 0.86, for a 5.5% reduction in σ/tₘ value at the higher operating level (larger L/D). At 0 RPM the σ/tₘ, decreased from 0.72 to 0.66, for an 8.3% reduction in σ/tₘ value at the higher operating level. At 0 RPM there would be no effect from the change from three blades to four blades, therefore the change can be attributable to the increased height and increase in L/D ratio. Additionally, the results suggest that RPM has a more dominant effect on plug flow compared to the L/D ratio in this comparative modeling.

TABLE 2
CSTR RTD analysis with four blades and an operating level of 92%.

| Parameter | σ/tₘ |
|---|---|
| 38 RPM, Standard Level | 0.95 |
| 38 RPM higher level | 0.95 |
| 9.5 RPM | 0.86 |
| 0 RPM | 0.66 |

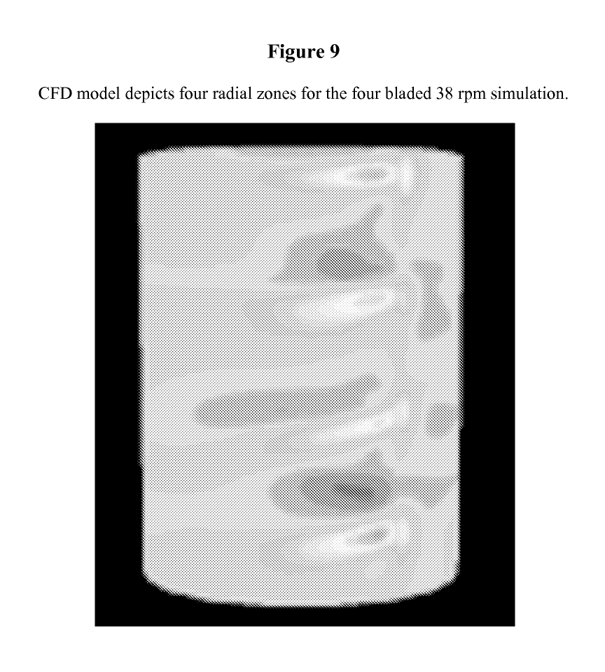

The modified model shows to approach plug flow behavior more rapidly with four blades as compared to the baseline model. Also, the operating level does show to change RTD significantly. The mixing zones, as noted in the original model, however, still allow for particle turbulence, promoting the CSTR behavior. FIG. 8 illustrates that a reduction in rotational speed has a significant effect on the RTD of the fluid passing through the reactor. FIG. 9 shows the CFD model that depicts four radial zones for the four bladed simulation at 38 rpm.

### Example 3

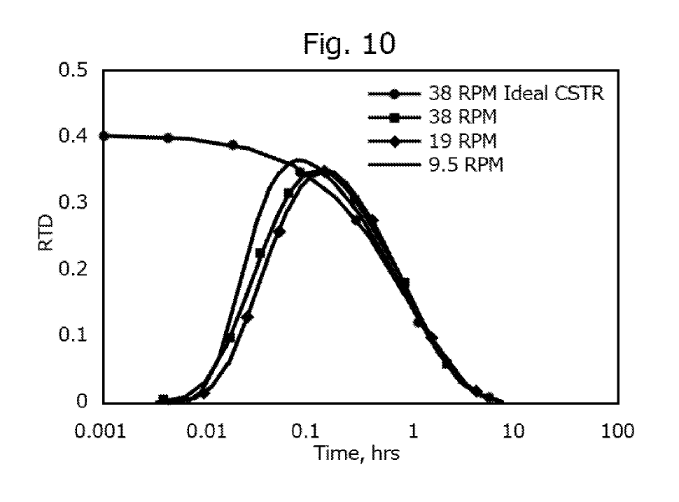

A third model was developed to evaluate an alternate reactor with four horizontal blades, no longitudinal baffles and an operating level of 68%. The computational fluid dynamics (CFD) model provided significant results suggesting that the horizontal blades allow for a more uniform flow with well-defined agitation zones. As such, it can be concluded that the agitator orientation and removal of baffles can play a major role in improving the plug flow behavior of a CSTR. Additionally, the RTD for the horizontal blades was shown to resemble a plug flow reactor, as shown in FIG. 10. The deviation based on RPM was seen to be minimized with the horizontal blades, thereby enabling the reactor to operate at the higher rotational speeds with minimal effect on the RTD. The higher rotational speeds can be beneficial for thermal dissipation within the reactor, as it can be important to have a uniform temperature profile within the CSTR to have a uniform polymerization throughout.

TABLE 3
CSTR RTD analysis with four horizontal blades and
an operating level of 68%.

| Parameter | σ/tₘ |
|---|---|
| 38 RPM | 0.88 |
| 19 RPM | 0.87 |
| 9.5 RPM | 0.9 |

Viewing the CFD model, it is apparent the plug flow behavior is due to the distinct mixing zones that the four horizontal blades promote. The distinct mixing zone between each blade removes the turbulence that is seen in the previous models.

As used herein the term “broadening” of a residence time distribution refers to an increase in the time span between the 10% and 90% points of the area under the curve on a RTD versus time plot.

As used herein the term “narrowing” of a residence time distribution refers to a reduction in the time span between the 10% and 90% points of the area under the curve on a RTD versus time plot.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A method for narrowing the residence time distribution of a liquid passing through a stirred-tank reactor, comprising:
providing a stirred-tank reactor having a liquid height and a rotating shaft containing a plurality of agitator blades, each agitator blade having a vertical cross-sectional area that depends on the agitator blade orientation;
wherein the agitator blades are distributed along the height of the reactor;
orientating the agitator blades so that the combined vertical cross-sectional area of the agitator blades is reduced sufficiently to narrow the residence time distribution of a liquid passing through the reactor.

2. The method of claim 1, wherein the agitator blades are horizontally oriented.

3. The method of claim 1, wherein the agitator blades are oriented to minimize the vertical cross-sectional area of the reactor's agitator blades.

4. The method of claim 1, wherein the RPM of the agitator blades is less than 50 RPM.

5. The method of claim 1, wherein the stirred-tank reactor comprises a liquid operating level of from 60% to 100%.

6. The method of claim 1, wherein the stirred-tank reactor does not comprise baffles.

7. The method of claim 1, wherein the reactor is used in the production of monovinylidene aromatic polymers.

8. The method of claim 1, wherein the reactor is used in the production of high impact polystyrene.

9. The method of claim 1, wherein the reactor comprises agitator blades at three or more locations along the height of the reactor.

10. A stirred-tank reactor that is capable of exhibiting characteristics of plug flow behavior, comprising:
stirred-tank reactor having a height and a rotating shaft containing one or more agitator blades, each agitator blade having a vertical cross-sectional area that depends on the agitator blade orientation;
wherein the agitator blades are distributed along the height of the reactor;
wherein the agitator blades are orientated so that the combined vertical cross-sectional area of the agitator blades is reduced sufficiently to narrow the residence time distribution of a liquid passing through the reactor.

11. The reactor of claim 10, wherein the agitator blades are horizontally oriented.

12. The reactor of claim 10, wherein the agitator blades are oriented to minimize the vertical cross-sectional area of the reactor's agitator blades.

13. The reactor of claim 10, wherein the RPM of the agitator blades is less than 50 RPM.

14. The reactor of claim 10, wherein the stirred-tank reactor can operate with a liquid level of from 60% to 100% of the reactor height.

15. The reactor of claim 10, wherein the stirred-tank reactor does not comprise baffles.

16. The reactor of claim 10, wherein the agitator blades each have a vertical cross-sectional dimension of from 0.25 inches to 3 inches.

17. The reactor of claim 10, wherein two or more agitator blades are distributed along the height of the reactor.

18. The reactor of claim 10, wherein three or more agitator blades are distributed along the height of the reactor.

19. The reactor of claim 10 that is used in the production of monovinylidene aromatic polymers.

20. The reactor of claim 10 that is used in the production of high impact polystyrene.
